(19) United States
(12) Patent Application Publication
(10) Pub. No.: US 2007/0012372 A1
(43) Pub. Date: Jan. 18, 2007

(54) Cover for fixation pin

(76) Inventors: Richard M. Jay, Philadelphia, PA (US); Joseph Jay Smith, Elkins Park, PA (US)

Correspondence Address: SYNNESTVEDT & LECHNER, LLP, 2600 ARAMARK TOWER, 1101 MARKET STREET, PHILADELPHIA, PA, 191072950, US

(21) Appl. No.: 11/173,510

(22) Filed: Jul. 1, 2005

(51) Int. Cl. F16L 55/10

(52) U.S. Cl. 138/95

(57) ABSTRACT

The present invention is directed to a cover for protecting the terminal end of a fixator pin proximate to the attachment point of the fixator pin to a frame member of a fixator device. The cover comprises at least first and second body portions in overlying relationship that, in combination, form an internal space adapted to receive the terminal end of the fixator pin proximate to the point of attachment with the frame member. The body portions may be designed to engage with each other or with one or more elements of the fixator frame. The present invention is also directed to a method for covering the terminal end of a fixator pin proximate to an attachment point to a fixator frame by enclosing the terminal end of the fixator pin within the cover of the present invention.

### FIELD OF THE INVENTION

This invention relates to fixator pin covers adapted for external fixators used in the treatment of acute trauma such as complex fractures, non-unions, malunions, bone defects, osteomyelitis, contracture, and for such procedures as limb lengthening and deformity correction.

### BACKGROUND OF THE INVENTION

About 2400 years ago, Hippocrates described a simple external fixator to splint a fracture of the tibia. The device consisted of closely fitting leather rings connected by wooden rods. The first use of percutaneous pins in an external fixator is attributed to Jean-Francois Malgaigne who, in 1840, described a metal pin driven into the tibia and held by leather straps. Drs. Clayton Parkhill of Denver and Albin Lambotte of Belgium independently invented the first practical external fixators, in 1897 and 1907, respectively. Then in 1938, Raoul Hoffman of Switzerland developed a fixator which allowed fractures to be mechanically manipulated and reduced. The Hoffman fixator, in its subsequent iterations and in hybrid forms, has become widely used in the treatment of fractures and other bone conditions.

In 1951, Professor Gavriil Abramovich Ilizarov of Kurgan, Siberia developed an external fixation device and techniques for lengthening long bones and correcting bone deformities. His technique revolutionized the management of many reconstructive problems that had previously been intractable. Unlike the fixators that had been developed in Europe and the United States, the Ilizarov fixator uses a series of rings or arches centered about a patient's limb. The rings or arches are connected to each other by means of one or more rigid members to form a frame around the limb that provides for stable bone fixation in three dimensions. The rings and/or rigid members are secured directly to the bone by means of crossed, tensioned pins, wires and/or screws (collectively referred to hereinafter as fixator pins).

The rigid members used to connect the rings or arches of an Ilizarov fixator may be rigidly affixed to the rings or threaded or telescopically arranged to allow for the precise adjustment of the relative position of the rings or arches to each other to affect the correction of a deformity, to lengthen the bone, or to transport bone fragments, as required by the appropriate therapy regime. Ilizarov fixators have also been used in correcting angular deformities of long bones which may result from malunion or disturbances of growth due to infection, tumor, rickets, Blount's disease or other causes, and have also played an important role in the treatment of fractures as they provide for the correct orientation of bone fragments relative to each other to promote proper healing. The precision of this orientation may be enhanced by, for example, the use of X-rays to aid in determining suitable anchoring points and the proper orientation of rings and pins relative to each other.

As compared with a cast, a fixator may be advantageous when the broken bone is prone to shift and change position within a cast. A fixator can also hold bone fragments much more rigidly and as compared to a cast, particularly where the many bone fragments exist. In most fixator systems, fixator pins are anchored into the bone at one end and to a frame element such as a ring, rod or rail at the other. The attachment of the fixator pin at the frame element may be accomplished in a variety of ways which understood in the art and include, for example, a tension or locking coupler system, clamps, bolts, clips, and other structures which are capable of securing the fixator pin to the frame element. Depending on the specific attachment mechanism that is used, a portion of the fixator pin may be exposed and protrude beyond the point of attachment thereby forming a free end that can contact and damage clothing, furniture and other objects in the patient's environment. Such contact may also cause damage to elements of the fixator such as, for example, damage to a pin or the attachment mechanism used to secure the pin to the frame. Further, such contact may result in discomfort and/or tissue damage to the patient.

### SUMMARY OF THE INVENTION

In accordance with one aspect of the invention, there is provided a cover for protecting the terminal end of a fixator pin proximate to the attachment point of the fixator pin to a frame member of a fixator device. The cover comprises at least first and second body portions in overlying relationship that, in combination, form an internal space adapted to receive the terminal end of the fixator pin proximate to the point of attachment with the frame member. The body portions may be designed to engage with each other and/or with one or more elements of the fixator frame. Preferably, the engagement of the body portions is accomplished by means of interlocking features that are integral thereto.

The body portions may be two or more discrete elements or two or more articulated elements of a unitary device. In preferred form, the body portions comprise a pair of complimentary elements each comprising a back wall and at least one side wall depending therefrom to define an internal space. In such embodiment, the side wall of the body portions are adapted to fit securely about the frame member proximate to the point of attachment by the terminal end of the fixator pin, and each body portion is provided with at least one complimentary pair of pins and sockets for the secure engagement of the body portions to each other.

In another aspect of the present invention, there is provided a method for covering the terminal end of a fixator pin proximate to an attachment point to a fixator frame by enclosing the terminal end of the fixator pin within a cover comprising two or more body portions in overlying relationship that, in combination, form an internal space that is adapted to receive the terminal end of the fixator pin.

### BRIEF DESCRIPTION OF THE DRAWINGS

FIG. 1 is a perspective view of the interior of one embodiment of a body portion of the cover of the present invention.

FIG. 2 is a perspective view of the exterior of the embodiment of a body portion shown in FIG. 1.

FIG. 3 is a top plan view of the interior of the embodiment of a body portion shown in FIG. 1.

FIG. 4 is a first cross-section view of the embodiment of a body portion shown in FIG. 1.

FIG. 5 is a second cross-section view of the embodiment of a body portion shown in FIG. 1.

FIG. 6 is a third cross-section view of the embodiment of a body portion shown in FIG. 1.

FIG. 7 is a perspective view of the interior of the embodiment of a body portion shown in FIG. 1 engaged with a portion of ring member of a fixator frame proximate to the attachment point for a fixator pin.

FIG. 8 is a perspective view of the interior of the embodiment of a body portion shown in FIG. 1 engaged with a portion of rod member of a fixator frame proximate to the attachment point for a fixator pin.

FIG. 9 is a perspective view of two pairs of complimentary body portions covering the terminal ends of two fixator pins proximate to the attachment point to a fixator frame, one engaged about a portion of a ring member and the other engaged about a portion of a rod member.

### DETAILED DESCRIPTION

One aspect of the present invention is directed to a cover for protecting the terminal end of a fixator pin proximate to its attachment to a frame member of a fixator device. The cover comprises two of more body portions positioned in overlying relationship with respect to the terminal end of a fixator pin proximate to the attachment point of the fixator pin to a fixator frame member. In such fashion, the cover forms a secure barrier between the terminal end of the fixator pin and the environment that protects both from harm. With minor variations in design to accommodate the specific dimensions and positions of frame elements of different fixators, the cover of the present invention is suitable for use with a variety of fixator devices in which the terminal ends of the fixator pins are exposed.

The body portions of the cover may be provided as two or more articulated elements to a unitary body or as discrete elements which are combined to form the cover. As a unitary body, the body portions are movably attached such as, for example, by means of a pivot or hinge connection so as to permit relative movement of the body portions. In one such embodiment, the body portions are arranged in hinged in a “clamshell” configuration to permit the placement of the body portions of the cover about the terminal end of a fixator pin when in an open position and the formation of a secure cover over the terminal end when in a closed position. In another embodiment, the cover comprises two or more discrete body portions that engage with each other and/or with the frame member proximate to the fixator pin attachment point. In one such embodiment, the cover comprises a complimentary pair of body portions.

The body portions are preferably provided with engagement elements which cooperate to secure the body portions to each other and/or a portion of the frame member proximate to the attachment point of a terminal end of a fixator pin so as to cover the fixator pin terminal end. The engagement elements may be in the form of interlocking, overlapping and/or complimentary elements that secure the body portions to each other and/or to the frame member. In one embodiment, the engagement elements comprise at least one complimentary pair of pin and socket elements. Alternatively, the engagement elements may comprise at least one complimentary pair of elements such as slot and groove elements, notched elements, hook and loop elements, dovetailed elements and the like; attachment elements such as screws, bolts, rivets, snaps, latches, straps, bands and the like; adhesives; or other such configurations and elements suitable for the interengagement of complimentary body portions known in the art.

In one embodiment, the engagement elements are capable of disengagement and subsequent and repeated re-engagement of the body portions. Alternatively, the engagement elements may be provided in a form that allows for single-use only by, for example, deformation of one or more of the engagement elements upon engagement of the body portions that prevents re-engagement, or the use of a locking mechanism that results in damage to or destruction of one or more engagement elements upon disengagement of the body portions.

The body portions may be adapted to fit over and/or around the various parts of a fixator frame. For example, the body portions may be adapted for fitting about a portion of a ring member and/or a rod member of an Ilizarov-type fixator. In such embodiments, the body portions are also adapted to receive the terminal end of a fixator pin where the fixator pin is attached to the frame, whether a ring member or a rod member. Where the attachment of the fixator pin to the frame is accomplished by means of an attachment element that extends beyond the dimensions of the frame member to which it is attached, the body portions of the cover may be adapted to accommodate such extensions. Such adaptation may involve an expanded internal space in order to enclose the extension within the internal space of the cover. Alternatively, such adaptation may include one or more apertures provided in the body portions of the cover that are sized to accommodate the protrusion of the extending portions of the attachment element while maintaining a secure fit over the terminal end of the fixator pin. One or more apertures may also be provided to allow access to the structures of the fixator within the internal space of the cover such as, for example, to permit the tightening or screws, or to facilitate the disengagement of body portions from each other such as, for example, by means of one or more slots at the seam between body portions adapted for the insertion of a separator for prying apart the body portions.

The body portions may be formed from any of a variety of suitable materials including various natural and synthetic polymers such as plastics and rubbers, ceramics, metals, composite materials, and combinations thereof. In preferred form, the body portions comprise polymers such as polyethylene, polypropylene, polystyrene, acrylonitrile butadiene styrene, styrene-butadiene copolymers such as the copolymer sold under the trademark K-RESIN® by Chevron Phillips Chemical Company, polyoxymethylene such as the acetal copolymer sold under the trademark CELCOM® by Ticona Engineering Polymers, or thermoplastic elastomers such as the styrenic tri-block copolymer sold under the trademark MONPRENE® by Teknor Apex. In a further embodiment, the body portions may be coated with one or more additional materials in order to impart additional properties to the cover such as, for example, added protection and/or comfort. In preferred form, the materials comprising the body portions are suitable for being sterilized by known methods including, for example, autoclaving.

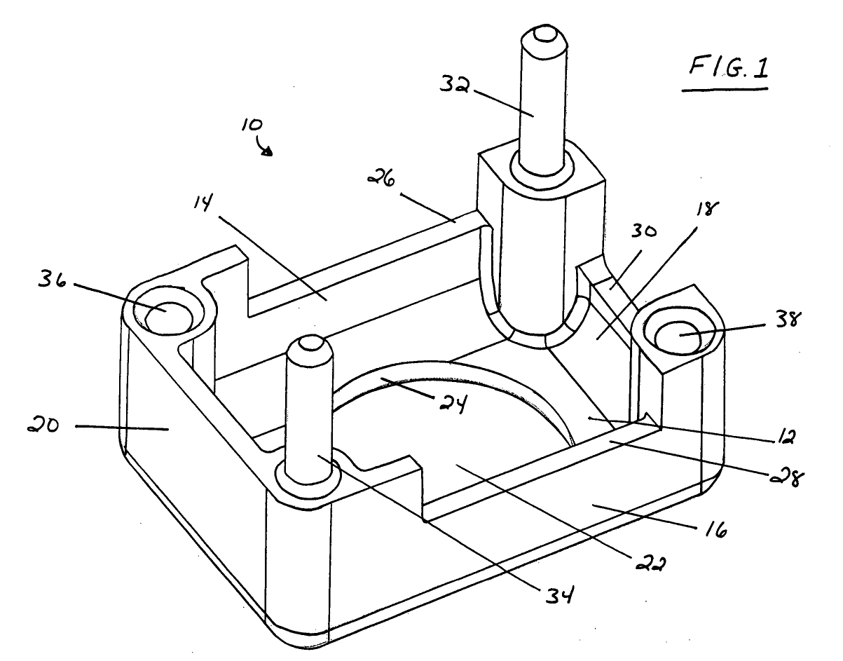

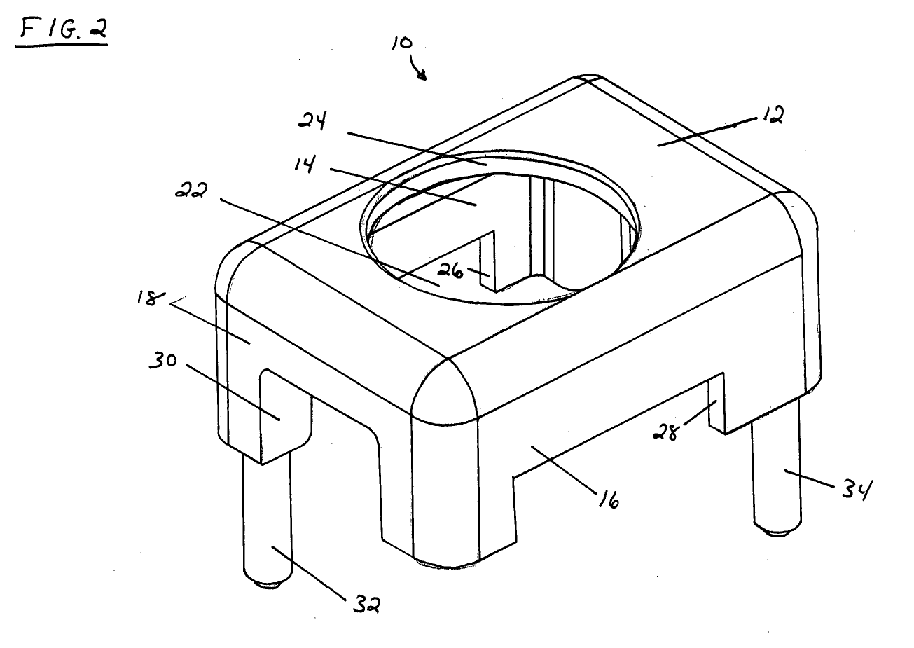

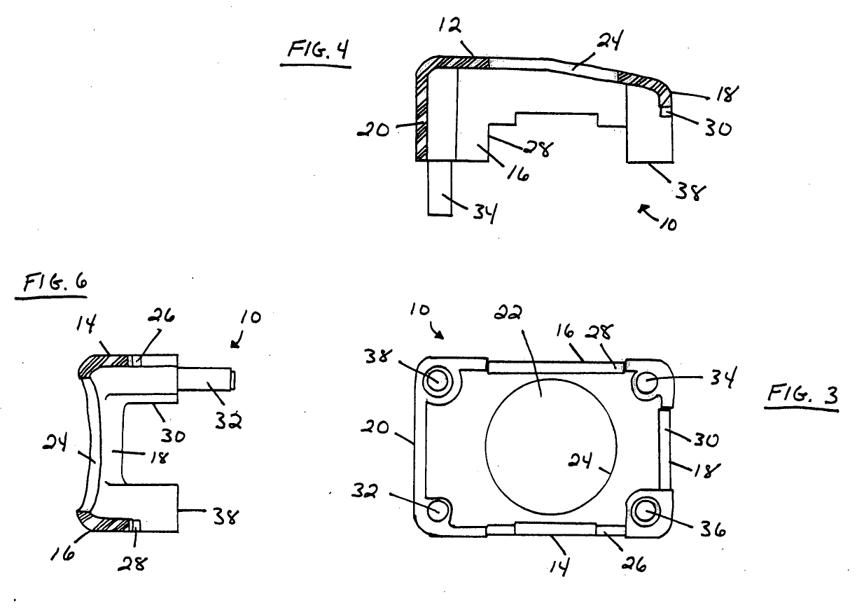

In one embodiment, the cover comprises a pair of complimentary body portions each comprising a back wall and at least one side wall depending therefrom to define an internal space adapted to receive the terminal end of a fixator pin proximate to its attachment point to a fixator frame member. One example of such an embodiment is shown in FIGS. 1-5 which are described in greater detail below. Other embodiments considered within the scope of the present invention include concave body portions comprising, for example, hemispherical or hemi-ovoid elements, or other such configurations which, alone or in combination, provide for an internal space adapted to receive the terminal end of a fixator pin proximate to its attachment point to a fixator frame.

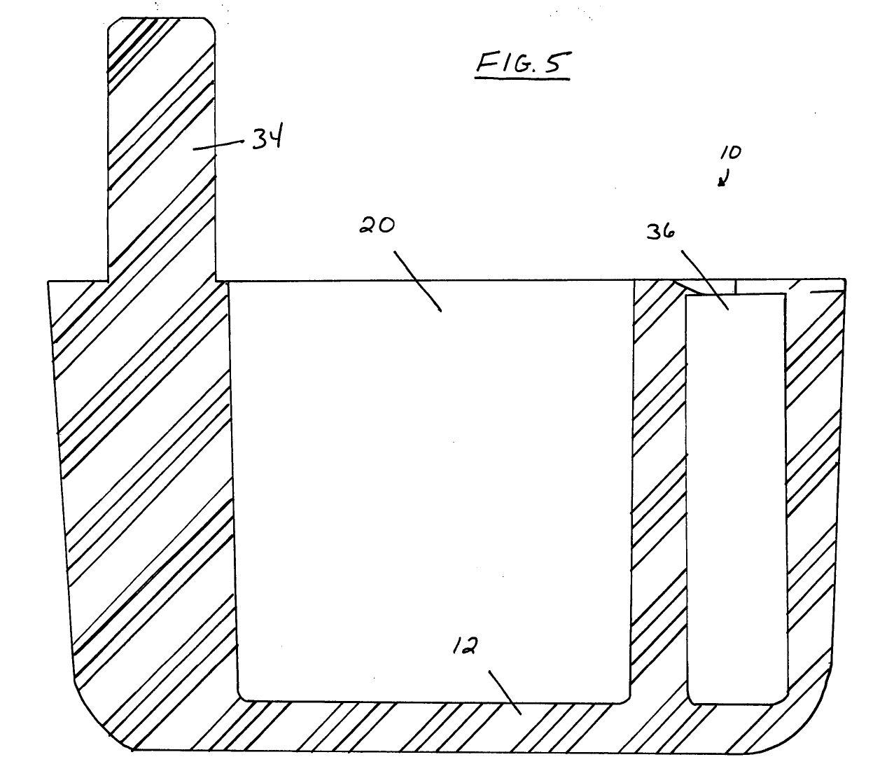

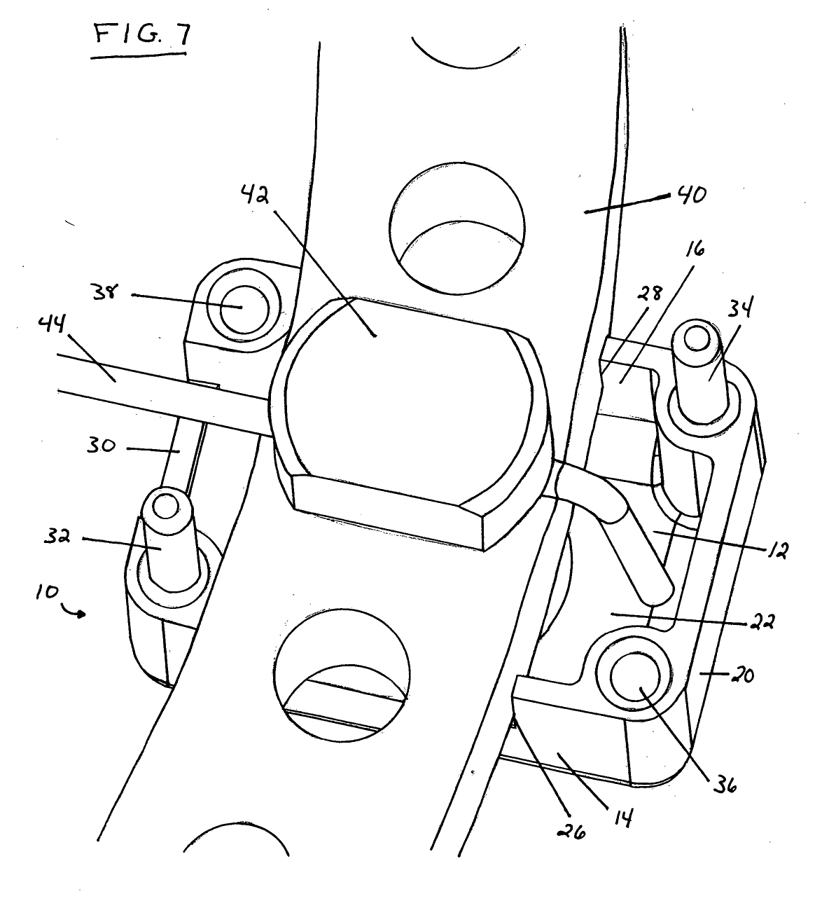

As shown in the embodiment depicted in FIGS. 1-6, body portion 10 comprises a rectangular back wall 12 and four side walls 14, 16, 18 and 20 that are oriented perpendicular to back wall 12 and depending therefrom to define an internal space 22 adapted to receive the terminal end of a fixator pin (not shown). Back wall 12 is provided with an aperture 24 adapted to receive a portion of the attachment element (not shown) extending beyond the dimensions of the frame member to which it is attached. Side walls 14 and 16 are configured with complimentary notches 26 and 28 sized for engagement with a portion of a frame member (not shown), and side wall 18 is configured with a notch 30 permitting the terminal end of a fixator pin to be received within internal space 22. Body portion 10 is also provided with pins 32 and 34 and sockets 36 and 38, each pair positioned at opposite corners. As a result of this orientation of pins and sockets, it will be understood that body portion 10 is one of two mirror image versions of body portion which, together with its opposite, forms a complimentary pair of body portions that can form a fixator pin cover when body portion 10 and a second body portion (not shown) that is complimentary to body portion 10 are positioned about a frame member proximate to the attachment point of a fixator pin so that pins 32 and 34 of body portion 10 engage with the sockets of the complimentary body portion and sockets 36 and 38 of body portion 10 engage with the pins of the complimentary body portion, the joined body portions form a cover over the attachment point.

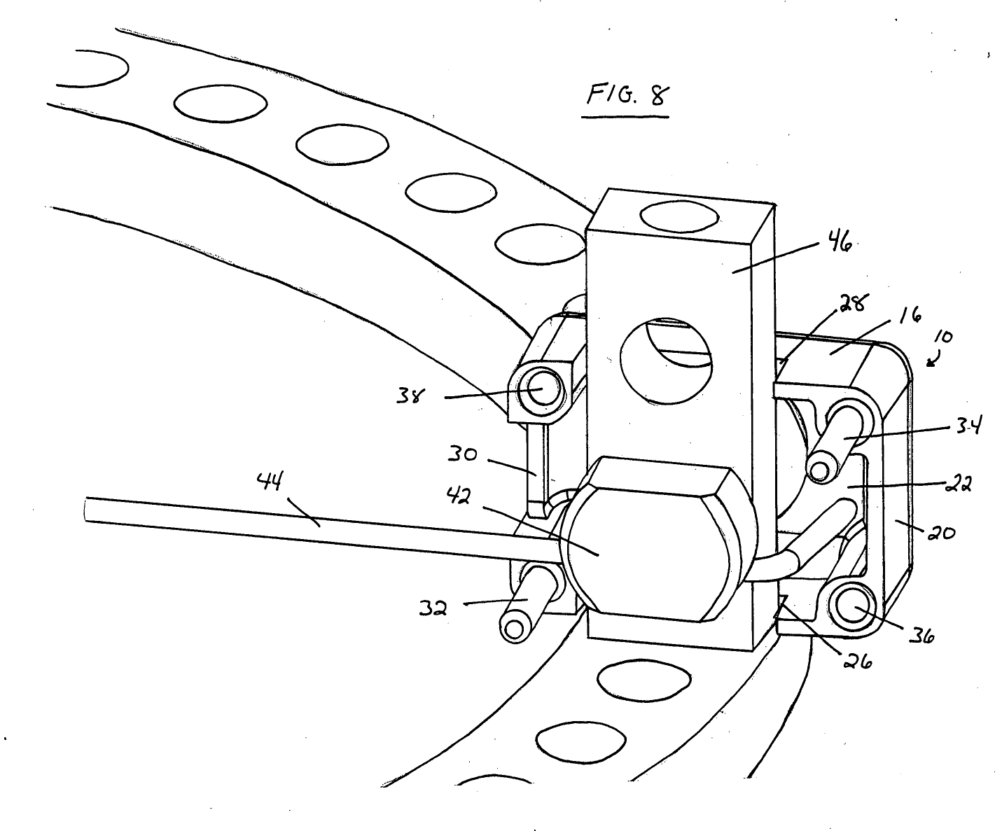

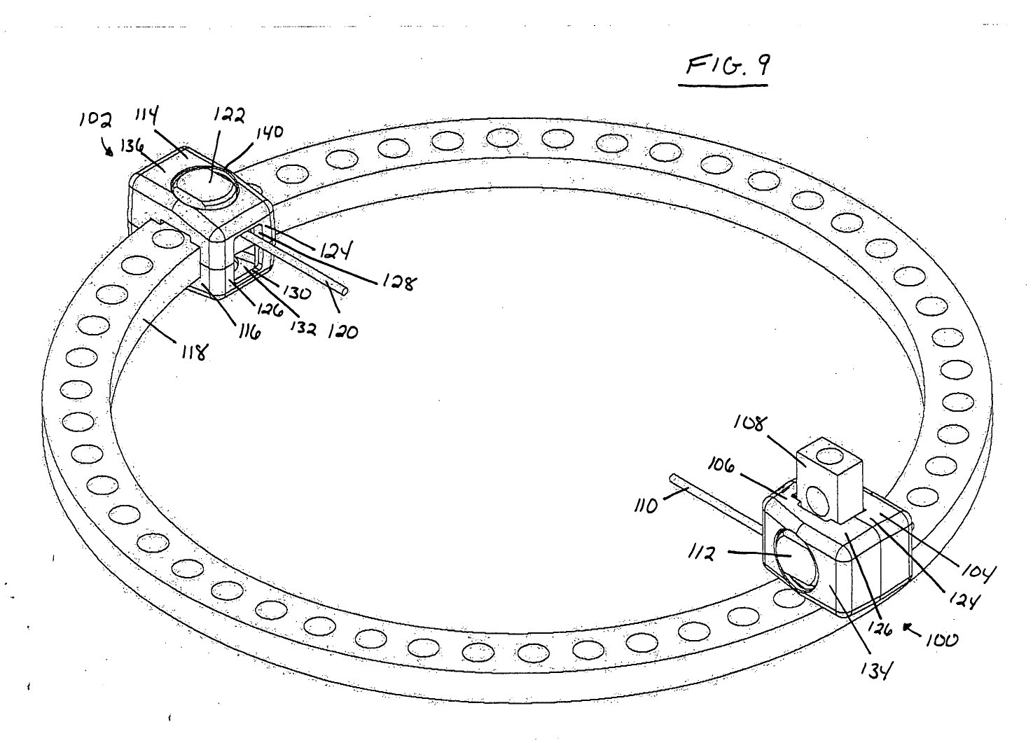

As shown in FIG. 7, body portion 10 is positioned over a portion of ring 40 so that notches 26 and 28 of side walls 14 and 16 are sized in relation to ring 40 and in an engagement therewith proximate to attachment element 42 and fixator pin 44. Terminal end 46 of fixator pin 44 is positioned through notch 30 in side wall 18 and within internal space 22. Similarly, in FIG. 8 body portion 10 is positioned over a portion of rod 46 so that notches 26 and 28 of side walls 14 and 16 are sized in relation to rod 46 and in an engagement therewith proximate to attachment element 42 and fixator pin 44.

FIG. 9 shows two covers 100 and 102 with each cover comprising complimentary pairs of body portions 104 and 106, and 114 and 116, each in overlying relationship. More specifically, body portions 104 and 106 of cover 100 are positioned about rod 108, fixator pin 110 and attachment element 112, and body portions 114 and 116 of cover 102 are positioned about ring 118, fixator pin 120 and attachment element 122. As shown on body portions 104 and 106, side walls 124 and 126 are provided with notches 128 and 130 such that the engagement of body portions 104 and 106 forms an opening 132 to accommodate the entry of fixator pin 110. And as shown in both covers 100 and 102, back walls 134 and 136 are each provided with apertures 138 and 140 that are sized to fit the portion of attachment elements 112 and 122 extending beyond the dimensions of rod 108 and ring 118, respectively. In this fashion, covers 100 and 102 are secured about the attachment points of fixator pins 110 and 120 so as to form a barrier between them and the wearer's clothes or items in the wearer's environment which may come in contact with the fixator.

Another aspect of the present invention is a method for covering the terminal end of a fixator pin proximate to its attachment point to a fixator frame by enclosing the terminal end of the fixator pin within a cover comprising two or more body portions in overlying relationship that, in combination, form an internal space adapted to receive the terminal end of the fixator pin. The method of the present invention may be accomplished by the step of applying the cover of the present invention as described more fully hereinabove to a terminal end of a fixator pin proximate to its attachment point to a fixator frame. This application step is preferably accomplished by the joining of complimentary body portions about the terminal end of a fixator pin so as to engage the body portions with each other or the frame member or both.

The engagement of the body portions may provide for the disengagement of the body portions by the use of engagement elements which are adapted to be capable of such disengagement. Further, such engagement may also provide for the subsequent re-engagement of the body portions by the use of engagement elements which are adapted to be capable of such re-engagement. Examples of engagement elements which are capable of disengagement and re-engagement include complimentary pin and socket elements provided on, and preferably integral with, the body portions of the cover. Alternatively, the engagement elements may permit single-use only by, for example, deformation upon engagement that prevents re-engagement or the use of locking mechanisms that result in damage to or destruction of one or more engagement elements upon disengagement of the body portions.

The method of the present invention is particularly well-suited to applications in which it is important to protect the structures of the fixator within the cover from tampering by the patient or from interaction with objects in the patient's environment.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

We claim:

1. A cover for protecting a terminal end of a fixator pin proximate to an attachment point of the fixator pin to a frame member of a fixator device, the cover comprising at least first and second body portions in overlying relationship that, in combination, form an internal space adapted to receive the terminal end of the fixator pin proximate to the attachment point with the frame member, and an attachment mechanism for securing the body portions to each other or to the frame member.

2. The cover of claim 1, wherein the attachment mechanism engages each body portion by interlocking features that are integral thereto.

3. The cover of claim 1, wherein the body portions are provided as two or more discrete elements

4. The cover of claim 1, wherein the body portions are provided as two or more articulated elements of a unitary device that are movably attached so as to permit relative movement of the body portions.

5. The cover of claim 4, wherein the body portions are pivotably attached.

6. The cover of claim 1, wherein the attachment mechanism comprises at least one pin positioned on the first body portion and a socket positioned on the second body portion and sized to accommodate the pin so that the pin engages with the socket upon engaging the body portions about the frame member of the fixator device.

7. The cover of claim 1, wherein the attachment mechanism further comprises a locking mechanism.

8. The cover of claim 1, wherein the attachment mechanism is capable of disengagement and subsequent re-engagement.

9. The cover of claim 1, wherein the body portions are formed from one or more polymers selected from the group consisting of polyethylene, polypropylene, polystyrene, acrylonitrile butadiene styrene, styrene-butadiene copolymers, polyoxymethylene, thermoplastic elastomers, and mixtures thereof.

10. The cover of claim 1, wherein the body portions are provided with at least one aperture.

11. The cover of claim 1, wherein the body portions each comprise a back wall and at least one side wall depending therefrom to define an internal space wherein the side walls of the body portions are adapted to fit securely about the frame member proximate to the attachment point by the terminal end of the fixator pin.

12. The cover of claim 11, wherein the back walls of the body portions are rectangular and each body portion is provided with four side walls.

13. The cover of claim 11, wherein the attachment mechanism comprises at least one complimentary pin and socket.

14. The cover of claim 11, wherein the attachment mechanism comprises complimentary pairs of pins and sockets each pair being positioned at opposite corners of the first and second body portions.

15. The cover of claim 11, wherein the body portions are formed from one or more polymers selected from the group consisting of polyethylene, polypropylene, polystyrene, acrylonitrile butadiene styrene, styrene-butadiene copolymers, polyoxymethylene, thermoplastic elastomers, and mixtures thereof.

16. The cover of claim 11, wherein the body portions are provided with at least one aperture.

17. A method for covering the terminal end of a fixator pin proximate to an attachment point to a fixator frame by enclosing the terminal end of the fixator pin within the cover of claim 1.

18. A method for covering the terminal end of a fixator pin proximate to an attachment point to a fixator frame by enclosing the terminal end of the fixator pin within the cover of claim 11.

19. An external fixator comprising:
a frame;
at least one fixator pin having a terminal end attached to the frame at an attachment point;
a cover for protecting the terminal end of the fixator pin proximate to the attachment point, the cover comprising at least first and second body portions in overlying relationship that, in combination, form an internal space adapted to receive the terminal end of the fixator pin proximate to the frame; and
an attachment mechanism for securing the body portions of the cover to each other or to the frame.

20. The external fixator of claim 19, wherein the first and second body portions each comprise a back wall and at least one side wall depending therefrom to define an internal space wherein the side walls of the body portions are adapted to fit securely about the frame proximate to the attachment point by the terminal end of the fixator pin.
